(19) United States
(12) Patent Application Publication
(10) Pub. No.: US 2008/0250427 A1
(43) Pub. Date: Oct. 9, 2008

(54) APPARATUS AND METHOD FOR GENERATING VERIFICATION SPECIFICATION OF VERIFICATION TARGET PROGRAM, AND COMPUTER READABLE MEDIUM

(75) Inventor: Hiromasa Shin, Yokohama-Shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/040,987

(22) Filed: Mar. 3, 2008

(30) Foreign Application Priority Data
Mar. 27, 2007 (JP) 2007-81612

(51) Int. Cl. G06F 9/46

(52) U.S. Cl. 719/318

(57) ABSTRACT

There is provided with an apparatus which generates a verification specification for verifying a verification target program including functions operating one or more object, including: a first input unit configured to input a first specification describing a first finite state machine which defines transitions among plural states due to occurrences of events; a second input unit configured to input a second specification describing for a first object type, correspondence between functions operating an object having the first object type and the events in the first finite state machine; and a verification specification generation unit configured to generate a verification specification for verifying the verification target program by synthesizing the first and second specifications, the verification specification describing a second finite state machine which defines the transitions among states of the object having the first object type due to calls of the functions operating the object having the first object type.

### CROSS REFERENCE TO RELATED APPLICATIONS

This application is based upon and claims the benefit of priority from the prior Japanese Patent Applications No. 2007-81612, filed on Mar. 27, 2007; the entire contents of which are incorporated herein by reference.

### BACKGROUND OF THE INVENTION

1. Field of the Invention

The present invention relates to an apparatus which generates a verification specification for verifying a verification target program, a method thereof and a computer readable medium storing a computer program for generating the verification specification.

2. Related Art

A well-known technique called a type state verification exists among the verification techniques for detecting a logical error in a computer program. The type state verification involves inputting a program code of verification object and a verification specification described by the user and making the verification without executing the program. Incidentally, as the relevant documents, Non-Patent Document 1 and Non-Patent Document 2 exist wherein Non-Patent Document 1 is “Checking System Rules Using SystemSpecific, Programmer-Written Compiler Extensions.” In Proceedings of the Fourth Symposium on Operating Systems Design and Implementation, San Diego, Calif., October 2000 (Dawson Engler, Benjamin Chelf, Andy Chou, and Seth Hallem), and Non-Patent Document 2 is “Esp: Pathsensitive program verification in polynomial time” In Proceedings of the ACM SIGPLAN 2002 Conference on Programming language design and implementation (Manuvir Das, Sorin Lerner, and Mark Seigle).

The verification specification for the type state verification is one of abstracting a change in the state of an object variable appearing in the program code into a finite state machine. A verification algorithm for the type state verification is as follows. That is, the finite state machine makes a transition according to an operation on the object variable designated by the user, while searching a control flow graph of the program code, and investigates the presence or absence of transition to an invalid state, in which if any transition to the invalid state exists, a transition path is displayed as a counter-example.

The type state verification offers several advantages: it directly takes the program code as verification target, it does not need to execute the program, and it examines all possible execution paths of the program. On the other hand, a disadvantage of the type state verification is a point that an error report (false counter-example) regarding the actually unfeasible path occurs because the variable value or branch target in the program code is treated as unsettled and the verification result is incorrect.

In making a type state verification, the user is required to describe correctly a finite state machine in which the internal states of object variables to be verified are abstracted. If the type state verification is performed by describing a verification specification for a large program code, the following situations may occur.

1. Plural different objects often make similar state transitions, in which if the verification specification is individually described, a great amount of description is duplicated.

2. If the number of states in the finite state machine is large, it is difficult to describe the verification specification without mistake.

3. It is difficult to judge whether or not the counter-example reported in the type state verification occurs actually.

The present invention provides a program verification specification generating apparatus, method and program that can accomplish at least one of saving the amount of describing the verification specification, reducing the error in the complex verification specification, and reducing the false counter-example as much as possible.

### SUMMARY OF THE INVENTION

According to an aspect of the present invention, there is provided with an apparatus which generates a verification specification for verifying a verification target program including functions operating one or more object, comprising:

a first input unit configured to input a first specification describing a first finite state machine which defines transitions among plural states due to occurrences of events;

a second input unit configured to input a second specification describing for a first object type, correspondence between functions operating an object having the first object type and the events in the first finite state machine; and

a verification specification generation unit configured to generate a verification specification for verifying the verification target program by synthesizing the first and second specifications, the verification specification describing a second finite state machine which defines the transitions among states of the object having the first object type due to calls of the functions operating the object having the first object type.

According to an aspect of the present invention, there is provided with a method which generates a verification specification for verifying a verification target program including functions operating one or more object, comprising:

inputting a first specification describing a first finite state machine which defines the transitions among plural states due to occurrences of events;

inputting a second specification describing for a first object type, correspondence between functions operating an object having the first object type and the events in the first finite state machine; and

generating a verification specification for verifying the verification target program by synthesizing the first and second specifications, the verification specification describing a second finite state machine which defines the transitions among states of the object having the first object type due to calls of the functions operating the object having the first object type.

According to an aspect of the present invention, there is provided with a computer readable medium storing a computer program for causing a computer which generates a verification specification for verifying a verification target program including functions operating one or more object, to execute instructions to perform the steps of:

inputting a first specification describing a first finite state machine which defines the transitions among plural states due to occurrences of events;

inputting a second specification describing for a first object type, correspondence between functions operating an object having the first object type and the events in the first finite state machine; and

generating a verification specification for verifying the verification target program by synthesizing the first and second specifications, the verification specification describing a second finite state machine which defines the transitions among states of the object having the first object type due to calls of the functions.

### BRIEF DESCRIPTION OF THE DRAWINGS

FIG. 1 is a block diagram showing a program verification apparatus having a program verification specification synthesis device according to one embodiment of the present invention;

FIG. 2 is a flowchart schematically showing the operation of the program verification apparatus of FIG. 1;

FIG. 3 is a block diagram showing the detailed configuration of the program verification specification synthesis device (specification synthesis unit);

FIG. 4 is a view showing the relationship between an abstract specification and a concrete specification;

FIG. 5 is a view for explaining the abstract specification (file, mutual exclusion locks);

FIG. 6 is a view showing a transition table (fsm object) of the abstract specification;

FIG. 7 is a view showing a transition table (fsm mutex) of the abstract specification;

FIG. 8 is a view showing a truth table of assertion expression;

FIG. 9 is a view showing a transition table (without consideration of the assertion expression) for the finite state machine;

FIG. 10 is a view showing a transition table (in consideration of the assertion expression) for the finite state machine;

FIG. 11 is a view showing a correspondence relations table of concrete specification;

FIG. 12 is a diagram for explaining the conventional program verification;

FIG. 13 is a chart showing an example of control flow graph;

FIG. 14 is a chart for explaining an operation example (mutex_check1) of type state verification;

FIG. 15 is a chart for explaining an operation example (mutex_check2) of type state verification;

FIG. 16 is a view showing the finite state machine (verification specification) corresponding to the conventional verification specification 1; and

FIG. 17 is a view showing the finite state machine (verification specification) corresponding to the conventional verification specification 2.

### DETAILED DESCRIPTION OF THE INVENTION

After the conventional type state verification is briefly exemplified at first, the present proposal will be described below.

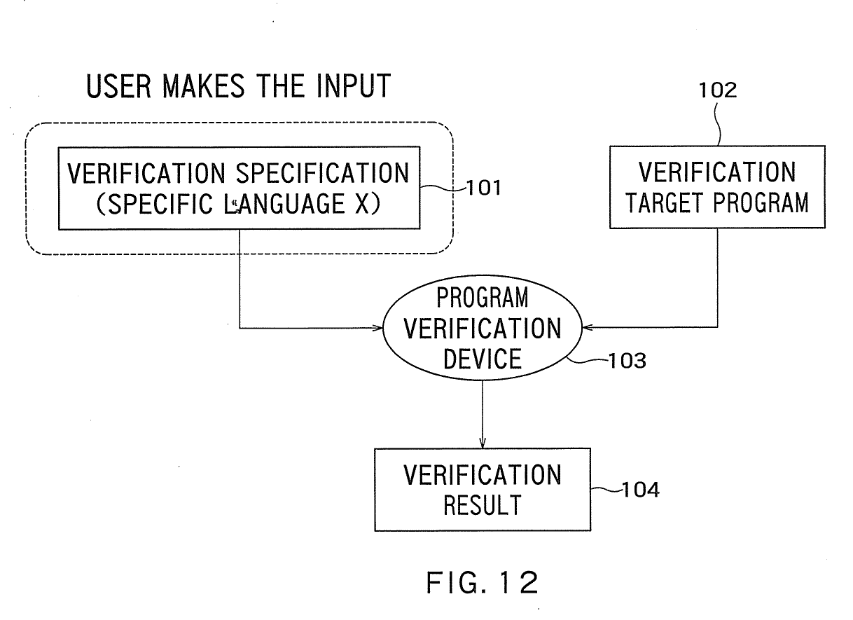

FIG. 12 is a diagram for explaining the conventional type state verification (see Non-Patent Document 1).

A verification specification 101 and a verification target program (or a program to be verified) 102 are inputted into a program verification apparatus 103. The program verification apparatus 103 performs the verification in accordance with a type state verification algorithm and outputs a verification result 104. The verification specification 101 is described in a specific language X, and the program verification apparatus 103 can interpret only the verification specification described in the specific language X.

An example 1 shows a verification target program. The example 1 performs the start operation for variables including a file variable f, mutual exclusion locks m and an integer x as the state variables, repeatedly performs the reading or writing of the file, and performs the end operation for variables to end the program. The terms “*” and “ . . . ” are substitution of a Boolean expression and some parameters for file operation.

### Example 1

### Verification Object

```
file f; // file
mutex m;  // mutual exclusion locks
int x;
f.fopen(“test.txt”);
m.init( );
while (*) {
  m.lock( );
  if (*) {
    x = f.read(..);
  }
  else {
    x = f.write(..);
    if (x < 0) break;
  }
  m.unlock( );
}
f.fclose( );
m.destroy( );
```

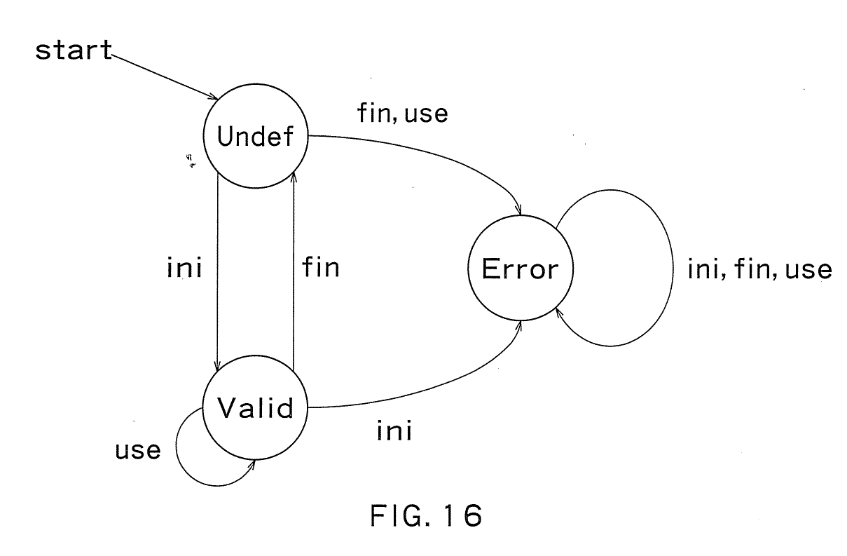

An example 2 shows a verification specification (verification specification 1). The verification specification 1 defines a finite state machine providing a use method of mutual exclusion locks. The structure of the finite state machine is shown in FIG. 16. This specification (name: mutex_check1) refers to an abstract state of a program variable type “{mutex}” with a symbol “v”. The state variable “v” is the occurrence of variable in the program with the initial state as “start”, and transits from “start” to an undefined state “v.undef”. If a start operation “v.init( )” is called, the variable “V” transits to an initialized state v.valid. Similarly, the transition between states v.undef and v.valid is also described. If the transition destination is {err( . . . )}, the state is prescribed as invalid. That is, this verification specification 1 inhibits the control of mutual exclusion locks before the start operation. The vertical line “1” included in the description of the verification specification 1 represents “or (OR)”. For example, in the undefined state “v.undef”, if v.init( ) is called, the state transits to the initialized state v.valid, and if v.call(args) is called, the state becomes invalid.

### Example 2

### Verification Specification 1

```
sm mutex_check1 {
  state decl { mutex } v;
  decl any_fn_call call;
  decl any_args args;
  start:
    { v } ==> v.undef;
  v.undef:
    { v.init( ) } ==> v.valid
  | { v.call(args) } ==> { err(“1”) };
  v.valid:
    { v.lock( ) } ==> v.valid
  | { v.unlock( ) } ==> v.valid
  | { v.destroy( ) } ==> v.undef
  | { v.call(args) } ==> { err(“2”) };
}
```

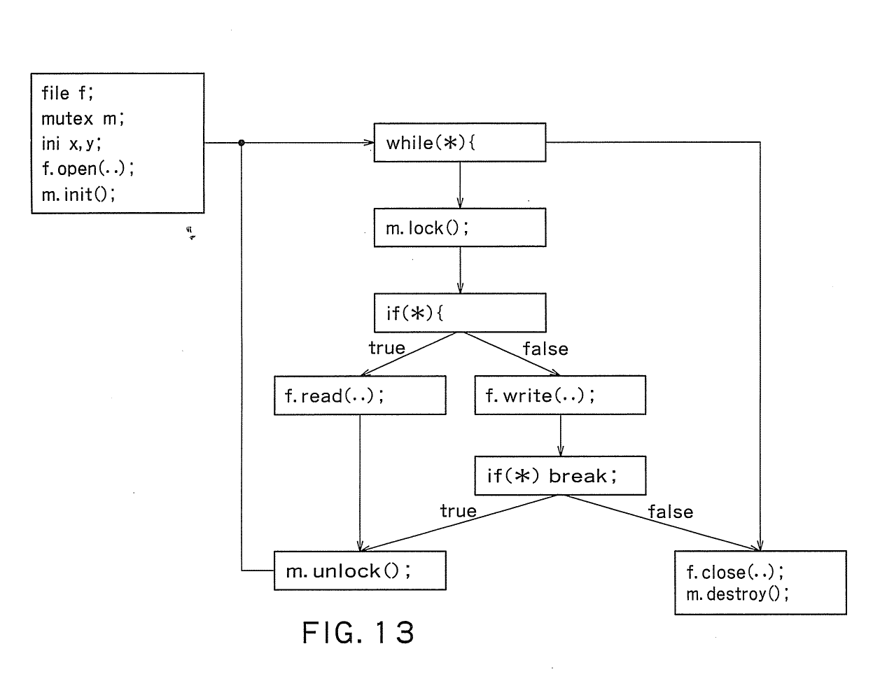

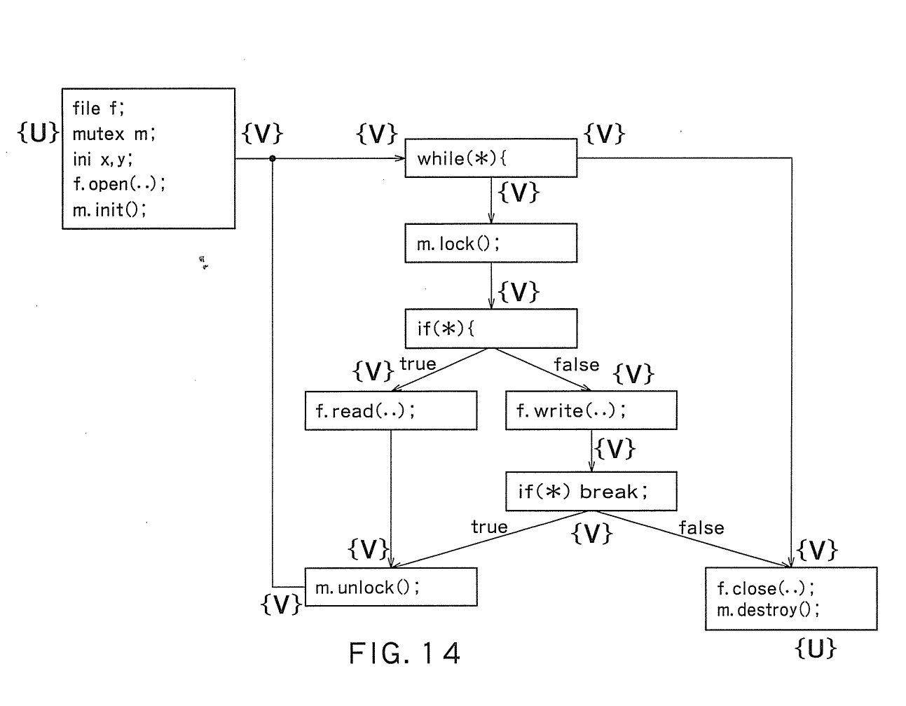

In the program verification apparatus X of FIG. 12, the verification target program as shown in the example 1 is converted into a control flow graph as shown in FIG. 13 in accordance with a well-known procedure. Each basic block in the control flow graph is the maximum code that does not include the branching or merging of programs. The basic blocks are connected by a directed edge indicating the branch target. The program verification apparatus X searches the control flow graph in an executable sequence, and every time the mutual exclusion locks m appears, the finite state machine defined in the verification specification 1 is made to transit. FIG. 14 shows an example in which the reachable states are recorded at the entry and exit of each basic block. “U” abbreviates the undefined state “undef” and “V” abbreviates the initialized state “v.valid”. In this example, no invalid transition is detected.

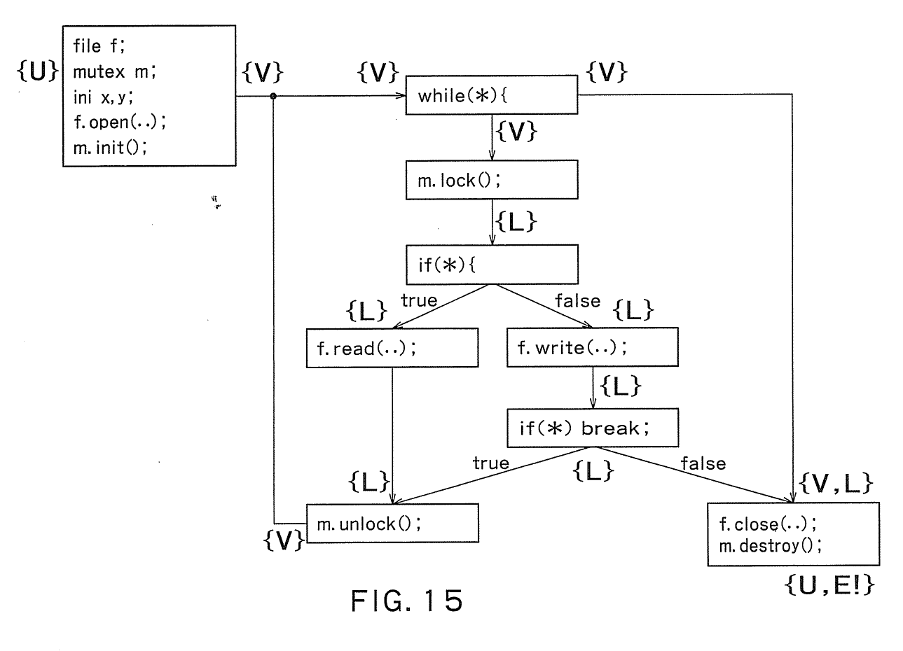

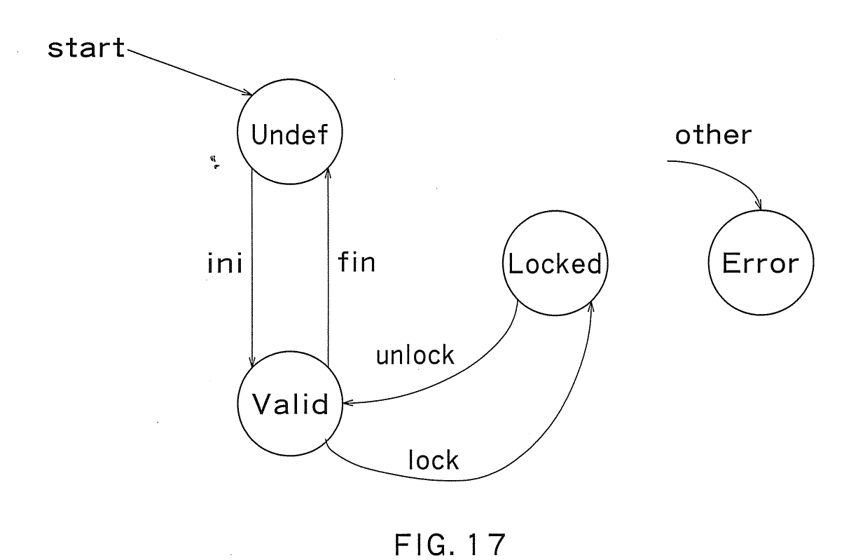

As a more detailed verification specification, the verification specification 2 in consideration of a locked state of mutual exclusion locks is shown in the example 3. This verification specification 2 defines the finite state machine with a structure as shown in FIG. 17. FIG. 15 shows an example in which the control flow graph is generated and the reachable states are recorded at the entry and exit of each basic block in the same manner as above in this example 3. “L” abbreviates the locked state “v.locked”. In the example of FIG. 15, there is a path where the end process “v.destroy( )” is performed in the locked state “v.locked”, and the state is determined as invalid.—

### Example 3

### Verification Specification 2

```
sm mutex_check2 {
  state decl { mutex } v;
  decl any_fn_call call;
  decl any_args args;
  start:
    { v } ==> v.undef;
  v.undef:
    { v.init( ) } ==> v.valid
  | { v.call(args) } ==> { err(“error1″) };
  v.valid:
    { v.lock( ) } ==> v.locked
  | { v.destroy( ) } ==> v.undef
  | { v.call(args) } ==> { err(“error2″) };
  v.locked:
    { v.unlock( ) } ==> v.valid
  | { v.call(args) } ==> { err(“error3″) };
}
```

If it is desired to examine the access to the file before the start operation, the verification specification can be generated by replacing “{mutex}” with “{file}” and replacing “v.init( )” with “v.open( )” in the verification specification 1 of the example 2.

In this manner, in the conventional verification specifications 1 and 2, the definition of the finite state machine and the definition of the correspondence with the program (correspondence with variable, correspondence with function) are described in the same specification description at the same time.

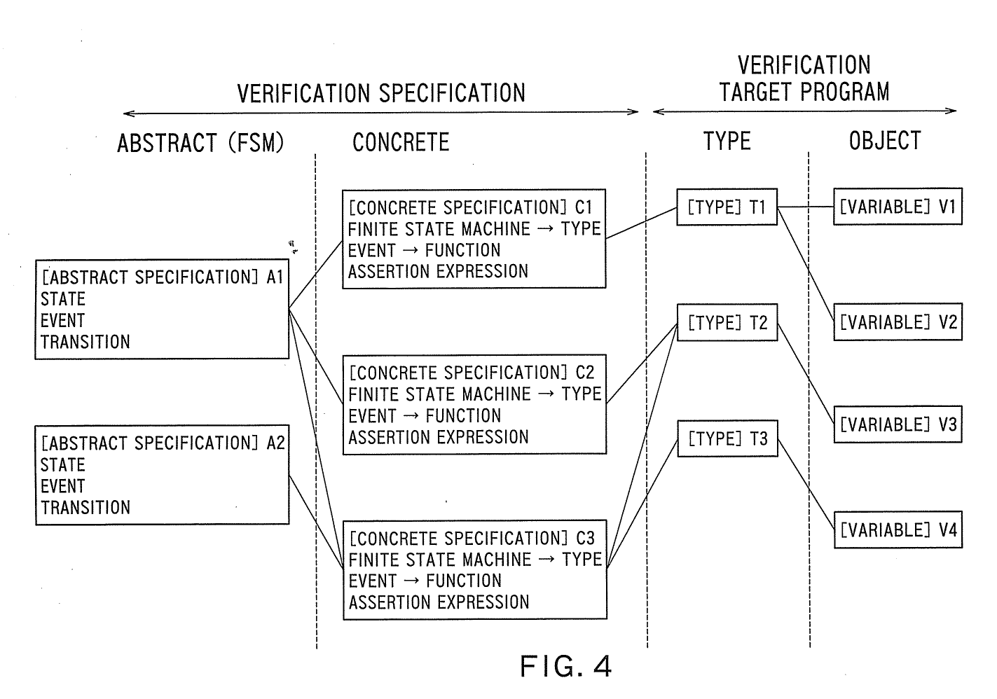

In this embodiment, the verification specification is described in an abstract specification and a concrete specification. Thereby, the abstract specification can be shared. More particularly, in the abstract specification, the finite state machine is defined by a plurality of states, a plurality of events, and the transitions among states due to occurrences of events, as shown in FIG. 4. Also, in the concrete specification, the correspondence between the finite state machine defined by the abstract specification and the Type (type) of program variable (object) in the verification target program is described, and the correspondence between the event of the finite state machine and the function in the verification target program is described. An assertion expression described in the concrete specification is one feature of this embodiment, and will be described later. The assertion expression may not be described. The verification specification is generated by synthesizing the abstract specification and the concrete specification. In the following, this embodiment will be described below in detail.

The examples 4 and 5 show the abstract specifications (abstraction specifications 1 and 2) according to this embodiment. Also, the examples 6 and 7 show the concrete specifications (concrete specifications 1 and 2). The abstract specification corresponds to the first specification and the concrete specification corresponds to the second specification.

The abstract specification 1 as shown in the example 4 is interpreted in the following manner. The finite state machine with the name “object” (first finite state machine identifier) defines the states “undef” and “valid”, the transition events (or simply events) “ini”, “fin” and “use”, and the transitions of state due to occurrence of transition events.

For example, if the transition event “ini” occurs in the state “undef”, the state transits to the state “valid”. All the transitions not explicitly defined are promised as the transitions to the error state. Namely, the abstract specification (first specification) describes the first finite state machine defining the transitions among plural states due to occurrences of events.

The concrete specification 1 as shown in the example 6 is interpreted as associating the finite state machine (abstract specification) “object” with the program variable type (object type) “file” and associating the transition event “ini” with the program function (function of operating the object having the type “file”) “open”. The name of the concrete specification 1 is “file”. The “f” described in the lower part of the concrete specification 1 and “m” described in the lower part of the concrete specification 2 are labels appended to the concrete specifications, which virtually represent the object having the above object type. In f.ini, the event “ini” for the object having the object type “file” is indicated.

In this embodiment, the abstract specification 1 and the concrete specification 1, and the abstract specification 2 and the concrete specification 2 are synthesized in a program verification specification synthesis device (specification synthesis unit) to generate the verification specification.

### Example 4

### Abstract Specification 1

```
// general-purpose object
fsm object {
    state: undef, valid;
    event: ini, fin, use;
    delta:
        (undef, ini -> valid),
        (valid, fin -> undef),
        (valid, use -> valid);
}
-----
```

### Example 5

### Abstract Specification 2

```
// exclusive control variable
fsm mutex {
    state: undef, valid, locked;
    event: ini, fin, lock, unlock;
    delta:
        (undef, ini -> valid),
        (valid, fin -> undef),
        (valid, lock -> locked),
        (locked, unlock -> valid);
}
-----
```

### Example 6

### Concrete Specification 1

```
// file operation
spec file {
    fsm(object): type(file) {
        ini: call(open(..));
        fin: call(close(..));
        use: call(read(..)) | | call(write(..));
    } f;
}
-----
```

### Example 7

### Concrete Specification 2

```
// lock operation
spec lock1 {
    fsm(object): type(mutex) {
        ini: call(init(..));
        fin: call(destroy(..));
        use: call(lock(..)) | | call(unlock(..));
    } m;
}
-----
```

Next, the verification regarding the combination of mutual exclusion locks of program and file is conceived as an example of more complex verification specification.

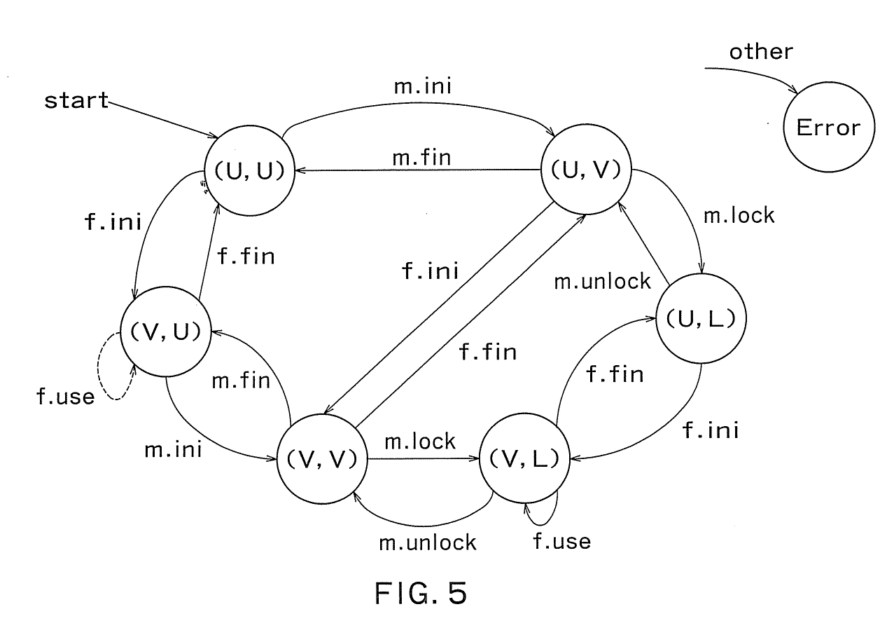

For example, suppose that one wants to confirm by verification that the mutual exclusion locks is in the locked state during the file operation. FIG. 5 shows an example of the corresponding finite state machine. The state labels were abbreviated as U=Undef, V=Valid and L=Locked. The state of the finite state machine is the combination of file and mutual exclusion locks. If there are two file states (U and V) and three mutual exclusion locks states (U, V and L), the number of states is (2*3+1)=7, including the error state. The invalid transition is indicated by the broken line, for example. This transition and all possible transitions with no definition are the invalid transitions to the error state (see “other” at the upper right in the figure). This verification specification (finite state machine) is simple in the configuration rules, but it is not easy to list and define all the states and transitions like the conventional verification specification. As a solution, the concrete specification describing the abstract specification to be combined with each type (file, mutex, etc.) and the “assertion expression (logical expression for assertion)” as described below is created.

The concrete specification 3 as shown in the example 8 is the concrete specification regarding a locked file operation, in which the abstract specifications “object” and “mutex” are associated with the program variable types “file” and “mutex”, and the transition event of program variable belonging to each type is defined.

More particularly, the concrete specification 3 describes two sets, for example, each including

a set of (1) object type (file), (2) first finite state machine identifier (object), and (3) correspondence between the function (open( . . . ), close( . . . ), etc.) of operating the object having the object type in the verification target program and the event (in, fin, etc.) included in the first finite state machine having the identifier (object), and

a set of (1) object type (mutex), (2) first finite state machine identifier (mutex), and (3) correspondence between the function (init( . . . ), destroy( . . . ), etc.) of operating the object having the object type in the verification target program and the event (ini, fin, etc.) included in the first finite state machine having the identifier (mutex).

Each state taken by the finite state machine based on the concrete specification 3 is basically the combination of states in each abstract specification for reference. However, the state or transition in which the “assertion expression” described by the user using the statement “assert” is false is the error state or the transition to error state.

That is, the transition destination of a set of state and transition event in which the assertion expression described using the statement “assert” is false is promised as the error state. For example, the meaning of the assertion expression “!f.use ∥ (f.use && m@locked)” in the example 8 is that when an event “use” of the variable “f” (object) occurs, the state of variable “m” (object) is “locked”. Namely, when the event “use” of variable “f” does not occur, or when the state of variable “m” is “locked” and the event “use” of variable “f” occurs, the statement “assert” is true (truth) (not error). The assertion expression is equivalent to the logical expression defining the constraint based on the state of object and the occurrence of event. The details of an algorithm for deciding the true/false value in the assertion expression will be described later.

In this embodiment, this concrete specification 3 and each abstract specification (“object”, “mutex”) used in the concrete specification 3 are synthesized in a program verification specification synthesis device (specification synthesis unit) as will be described later to generate the verification specification.

### Example 8

### Concrete Specification 3

```
// locked file operation
spec locked_file {
  fsm(object): type(file) {
    ini: call(open(..));
    fin: call(close(..));
    use: call(read(..)) || call(write(..));
  } f;
  fsm(mutex): type(mutex) {
    ini: call(init(..));
    fin: call(destroy(..));
    lock: call(lock(..));
    unlock: call(unlock(..));
  } m;
  assert(!f.use  ||  (f.use  &&  m@locked)); <-assertion
expression
}
```

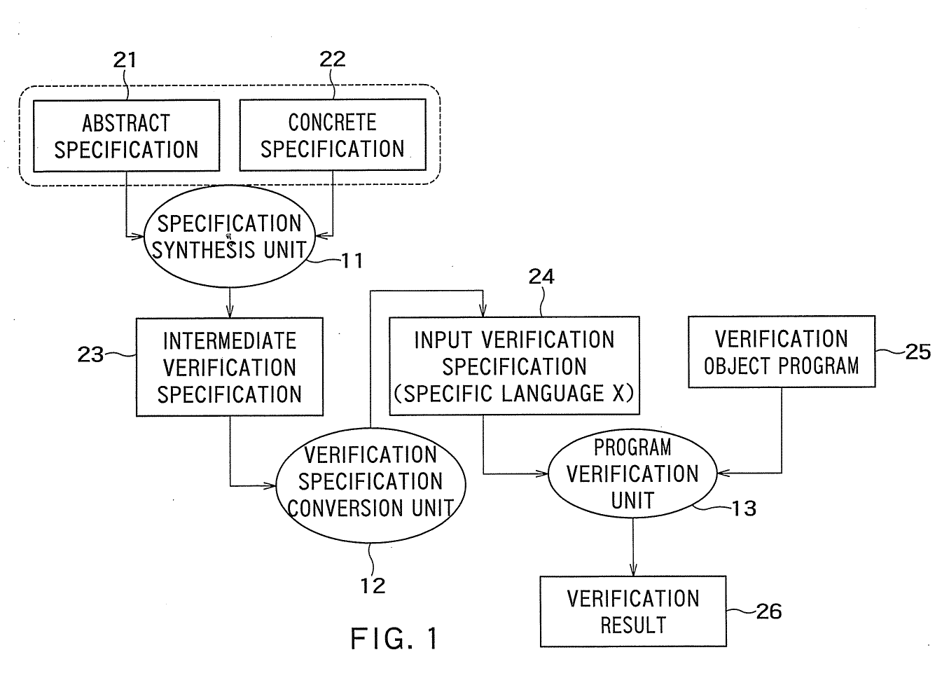

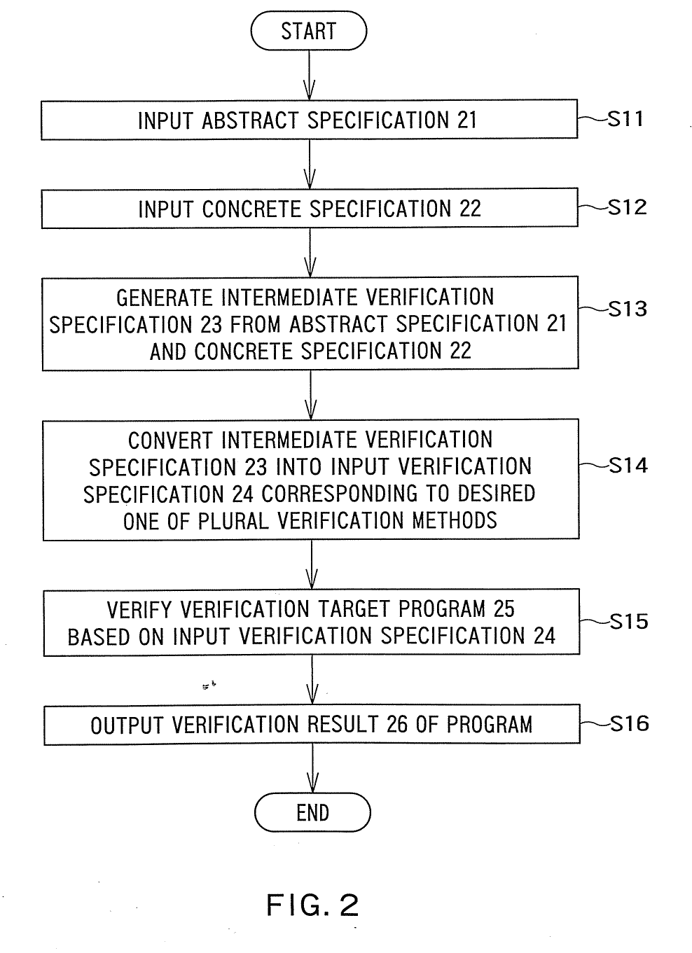

FIG. 1 is a block diagram showing the configuration of a program verification apparatus having the program verification specification generating apparatus (specification synthesis unit 11) according to this embodiment. FIG. 2 is a flowchart schematically showing the operation of the program verification apparatus. The operation of the program verification apparatus of FIG. 1 may be implemented by causing a computer to executing a program describing the instruction code performing each step as shown in the flowchart of FIG. 2. Also, the operation may be performed by causing a computer to read and execute the program describing the instruction code stored on a computer readable storage medium.

An abstract specification 21 (first specification) and a concrete specification 22 (second specification) are inputted into the program verification apparatus by the user using the input device (steps S11, S12). The specification synthesis unit (program verification specification generating apparatus) 11 generates an intermediate verification specification 23 from the input abstract specification 21 (first specification) and the concrete specification 22 (second specification) (step S13). A verification specification conversion unit 12 converts the generated intermediate verification specification 23 into an input verification specification 24 (verification specification describing the second or third finite state machine) corresponding to a desired one of plural verification methods (step S14). A program verification unit 13 verifies a verification target program 25 based on the verification specification (input verification specification) 24 (step S15), and outputs a verification result 26 of the program (step S16). It is possible to support plural verification methods by converting the intermediate verification specification 23 into the verification specification corresponding to the desired verification method. In this example, the intermediate verification specification is converted into the verification specification described in the specific language X. Thus, in this embodiment, the intermediate verification specification is once generated, and the generated intermediate verification specification is inverted into the verification specification corresponding to the desired verification method, whereby plural verification specification can be supported. Naturally, the verification specification (verification specification describing the second or third finite state machine) may be generated directly from the abstract specification and the concrete specification.

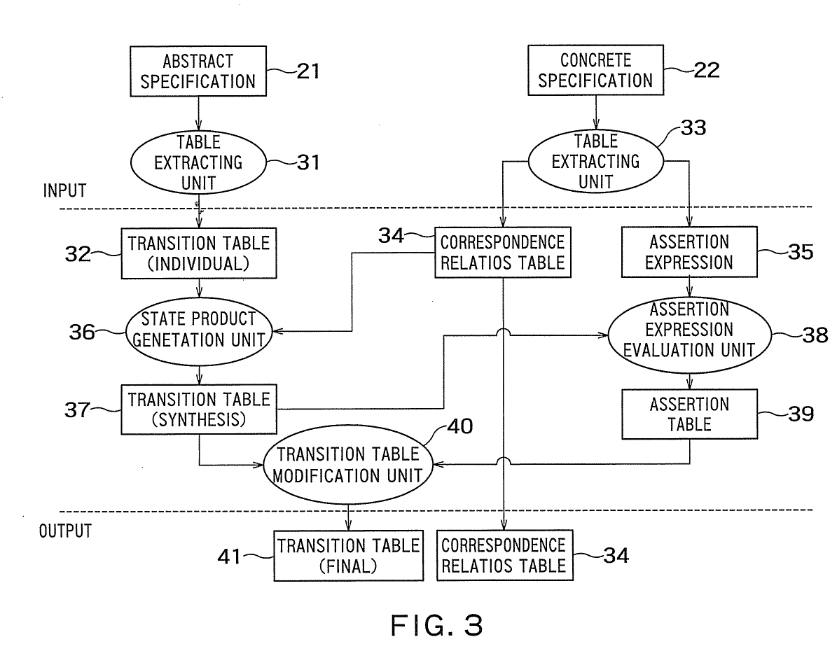

FIG. 3 is a block diagram showing in detail the configuration of the specification synthesis unit 11.

The table extracting units 31 and 33 are provided on the input side of the specification synthesis unit 11. The table extracting units 31 and 33 are provided outside the specification synthesis unit 11 here, but may be provided inside the specification synthesis unit 11.

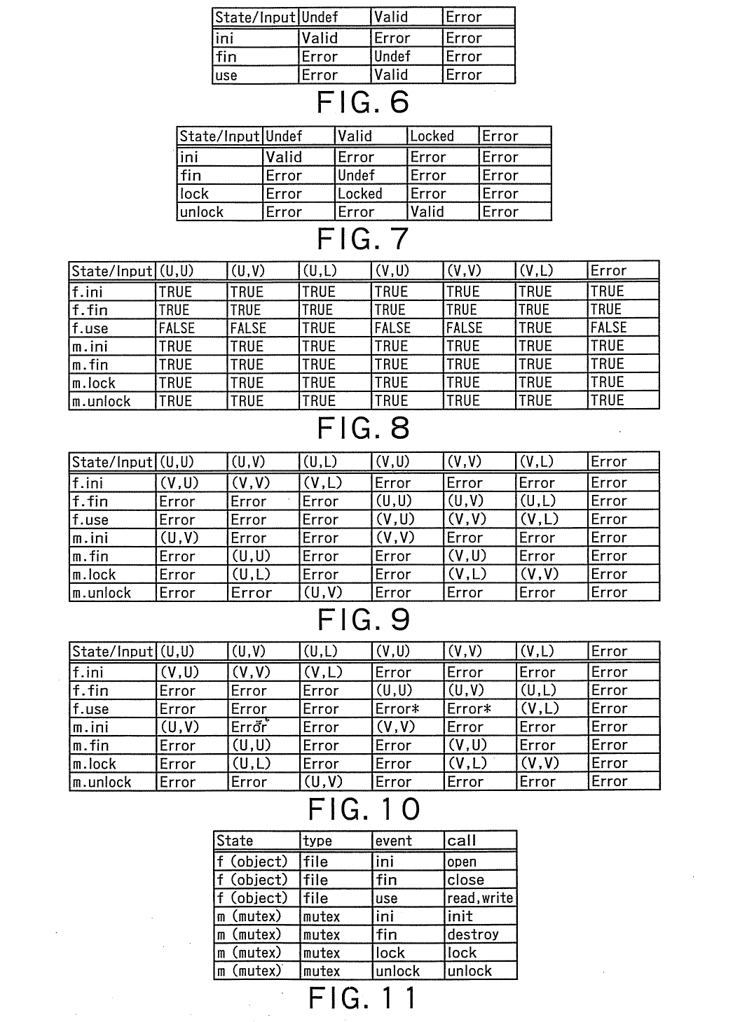

The table extracting unit 31 extracts a transition table (individual) 32 from each abstract specification 21. FIG. 6 shows an example of the transition table extracted from the abstract specification 1 with the name “object” as shown in the example 4, and FIG. 7 shows an example of the transition table extracted from the abstract specification 2 with the name “mutex” as shown in the example 5. The transition table (individual) 32 represents the state of transition destination from the set of state and event. For example, in FIG. 6, if the event “ini” occurs in the “Undef”, the state transits to Valid. The abstract specification is equivalent to the transition table extracted from the abstract specification. The abstract specification is managed in the form of the transition table on the computer. Though the transition table (individual) is extracted from the abstract specification 21 and the extracted transition table (individual) is inputted into the specification synthesis unit 11 here, the transition table (individual) may be created beforehand, and directly inputted into the specification synthesis unit 11. In this case, the table extracting unit 31 may be omitted.

The table extracting unit 33 extracts a correspondence relations table 34 and an assertion expression 35 from the concrete specification 22. FIG. 11 shows an example of the correspondence relations table extracted from the concrete specification 3 as shown in the example 8. Also, the assertion expression 35 extracted from the concrete specification 3 is “!f.use ∥ (f.use && m@locked)”. The correspondence relations table associates each object type with the abstract specification, and associates the event in the abstract specification with the function of operating the object having the object type corresponding to the abstract specification. A portion of the concrete specification 3 excluding the assertion expression is equivalent to the correspondence relations table of FIG. 11. The portion excluding the assertion expression is managed in the form of the correspondence relations table on the computer. Though the correspondence relations table 34 and the assertion expression 35 are extracted from the concrete specification 22, and inputted into the specification synthesis unit 11 here, a set of the correspondence relations table and the assertion expression may be prepared beforehand and inputted directly into the specification synthesis unit 11. In this case, the table extracting unit 33 may be omitted.

A state product generation unit 36 synthesizes the transition tables (individual) 32 extracted from the abstract specifications 21 based on the correspondence relations table 34 to obtain a transition table (synthesis) 37. FIG. 9 shows the transition table (synthesis) 37 obtained by synthesizing the transition tables of FIGS. 6 and 7 based on the correspondence relations table of FIG. 11. The transition table 37 shows the transition destination when the event of each type (file, mutex, etc.) in the concrete specification 22 occurs in the combination of states in each transition table (individual) 32 (combination in which any one is error is treated as the error state (Error)). For example, when the event “ini (f.ini)” regarding the object of file type occurs in the state (U, U), the state transits to the state (V, U).

An assertion expression evaluation unit 38 generates an assertion table 39 from the assertion expression 35 and the table format of the transition table (synthesis) 37 (the value at the intersection between transverse item and vertical item is not employed). FIG. 8 shows the assertion table 39 generated from the table format of the transition table (synthesis) 37 of FIG. 9 and the assertion expression “!f.use ∥ (f.use && m@locked)”. The assertion table 39 is generated in the following manner. If the set of transverse item (state) and vertical item (event) satisfies the assertion expression 35 in the format of the transition table (synthesis) 37 of FIG. 9, TRUE (true) is inputted into the grid corresponding to the set, or if the set does not satisfy the assertion expression 35, FALSE (false) is inputted into the grid corresponding to the set. For example, the set of (U, U) and “f.ini” corresponds to “!f.use” in the assertion expression 35, and satisfies the assertion expression, whereby “TRUE” is inputted into the applicable grid (upper left grid). Also, since the set of (U, U) and “f.use” does not satisfy any of “!f.use” and “(f.use && m@locked)”, “FALSE” is inputted to the applicable grid (third grid from the upper left). Also, since the set of (V, L) and “f.use” satisfies “(f.use && m@locked)”, “TRUE” is inputted into the applicable grid. The detailed generation algorithm of the assertion table 39 will be described later.

A transition table modification unit 40 modifies the transition table (synthesis) 37 based on the assertion table 39 to generate a transition table (final) 41. FIG. 10 shows an example of the transition table (final) in which the transition table (synthesis) 37 of FIG. 9 is modified based on the assertion table 39 of FIG. 8. The transition table (final) is generated in the following manner. For the grid that is “TRUE” in FIG. 8, the value of FIG. 9 corresponding to the concerned grid is directly used, or the grid that is “FALSE” in FIG. 8 is always “Error”. The “Error*” in the table of FIG. 10 indicates that this error is based on the assertion expression 35. That is, the value (not Error) of FIG. 9 is directly used for the grid containing “Error*”, unless there is the assertion expression 35.

The transition table (final) 41 generated by the transition table modification unit 40 and the correspondence relations table 34 extracted by the table extracting unit 33 are outputted from the specification synthesis unit 11. That is, the set of the transition table (final) 41 and the correspondence relations table 34 is equivalent to the intermediate verification specification 23 of FIG. 1.

Though the assertion expression is described in the concrete specification 22 in the above explanation, if the assertion expression is not described in the concrete specification 22, the set of the transition table (synthesis) 37 and the correspondence relations table 34 may be outputted as the intermediate verification specification 23, because it is not required to modify the transition table (synthesis) 37. For example, this is equivalent to a case where the abstract specification 1 of the example 4 and the concrete specification 1 of the example 6 are inputted into the specification synthesis unit 11, or a case where the abstract specification 2 of the example 5 and the concrete specification 2 of the example 7 are inputted into the specification synthesis unit 11.

In the following, the detailed algorithm of specification synthesis in the specification synthesis unit 11 will be described below as the procedures 1 to 4. The state product generation unit 36 corresponds to (1) to (3) of the procedure 1 and the procedure 2, the assertion expression evaluation unit 38 corresponds to the procedure 4, and the transition table modification unit 40 corresponds to (4) to (6) of the procedure 1 and the procedure 3.

In the following description, the finite state machine of verification specification is defined by M=(Q′, Σ, δ, q0, Q). The meaning of each symbol corresponds with the definition 1.

Definition 1: finite state machine

Q: state set of state statements (set of all states (accepted states) other than the error state)

Q′: all states=Q ∪ (error)

error: error state

Σ: symbol set of event statements

δ: transition function of state machine

Q′*Σ→Q′

The transition not stipulated in the delta statement is regarded as error transition.

The transition destination from the error state is all the error state.

q0: initial state (state declared at the beginning of the state statement)

The relevant transition table (individual) M[i] and the assertion expression “expr” are read from the concrete specification and abstract specification that are inputted and the transition table (final) M is outputted. The computation procedure of the transition function for use in the procedure 1 is described in the procedures 2 and 3.

Procedure 1: specification synthesis

Function: specification synthesis

Input: finite state machine M[1], . . . M[n], assertion “expr”

Output: finite state machine M

Case: table of FIG. 10

(1) A state set Q′ is obtained by generating the direct product of state sets Q[i] (not including the error state) for the finite state machine M[i] and including the error state.

That is, the state set of the finite state machine M is Q′=Q ∪ {error}.

Q: =(Q[1]*Q[2]* . . . *Q[n])

={(q1, q2, . . . , qn)|q1 in Q[1] ̂ . . . ̂ qn in Q[n]}

(2) The sum of event sets Σ[i] of the finite state machine M[i] is generated to have an event set Σ of M.

Σ: =Σ[1] ∪ Σ[2] ∪ . . . ∪ Σ[n]

={a|a in Σ[1] ν . . . ν a in Σ[n]}

(3) A transition function “trans(q, a)” without consideration of the assertion “expr” is defined in accordance with the procedure 2, and the transition table is computed.

(4) A truth-table “valid(q, a)” of the assertion “expr” is generated.

(5) The transition destination “trans(q, a)” is used when the value “valid(q, a)” of the assertion “expr” in the truth table is true, or the transition destination is error when it is false.

(6) This transition table “delta(q, a)” is a transition function δ of the finite state machine M.

The following procedure 2 decides the transition destination of the finite state machine having the product state without consideration of the assertion expression. The transition destination q of state set is decided by inputting the state set q and the transition event a. The location i of the state element corresponding to the transition event a is decided, and the state set where only the state of location i transits is q.

Procedure 2: transition function without consideration of assertion expression

Function: the transition “delta(q, a)” of the finite state machine without consideration of the assertion expression is computed.

Input: q:Q′, a:Σ, delta[i]: Q′[i]*Y[i]→Q′[i]

Output: p:Q′

Case: table of FIG. 9

trans(q:Q′, a:Σ):Q′:=

let q=(q[1], q[2], . . . , q[n])

var p=(p[1], p[2], . . . , p[2])

for each i in [1, 2, . . . , n] do
if a in Σ[i] then
   p[i]: delta[i](q[i],a)
else
   p[i]:=q[i]
endif
if p[i]=error then
   return error
endif

endfor

return p

The assertion expression used in the following procedure 3 is defined by the definition 2 described under the procedure 3, and the evaluation procedure uses the procedure 4. The procedure 3 decides the transition destination for each state q and the transition event a in consideration of the assertion expression by referring to the transition table (synthesis) without consideration of the assertion expression and the assertion expression. Specifically, if the value of the assertion table is true, the transition destination of the transition table (synthesis) is employed, or if the value of the assertion table is false, the transition destination is the error state.

Procedure 3: transition function in consideration of assertion expression

Function: the transition table of the finite state machine in consideration of the assertion expression is computed.

Input: transition table “trans(q, a)” and assertion table “valid(q, a)” without consideration of assertion expression

Output: transition table delta: Q′*Σ→Q′ in consideration of the assertion expression

Case: table of FIG. 10

delta(q:Q, a:Σ):Q=

if valid(q,a) then
return trans(q,a)

else
return error

endif

Definition 2: assertion expression (logical expression of assertion)

The logical expression is defined by BNF. The symbol “&&” means the logical product, the symbol “∥” means the logical sum, and the symbol “!” means the logical negation. The state variable “v@state” and the event symbol “v.event” take the true/false value according to the state and event.

expr::=v@state|v.event|expr && expr|expr∥expr|!expr

example) expr=(x@valid && y.use) && !(x@valid && z@locked)

The following procedure 4 is a computation procedure for the assertion table, in which if the state q and the event a are inputted, the true/false value of the assertion expression is decided. Specifically, after the true/false value is assigned to the state term “v@state” or the event term “v.event” of the logical expression, the true/false value of the assertion expression is decided in accordance with the evaluation procedure of the Boolean expression. The procedure 4 is the definition of the procedure of a recursive call method, in which if the current input expression e is in the logical product form, “and( . . . )” is called; if it is in the logical sum form, “or( . . . )” is called; if it is in the logical negation form, “not( . . . )” is called; and if it is state term or event term, the true/false value is assigned. If the number of recursive calls is increased, the number of logical operators is decreased, whereby this procedure is necessarily stopped and the value of the assertion expression is decided. The function “and( . . . )”, “or( . . . )”, or “not( . . . )” is the function for the normal Boolean value.

Procedure 4: evaluation of assertion expression

Function: the true/false value of the assertion expression for state q and event a is computed.

Input: assertion expression e, state q, event a

Output: true/false value (true or false)

Case: table of FIG. 8

valid(e:Exp, q:Q, a:Σ):bool:=

match e with
e1 && e2=> and(valid(e1,q,a), valid(e2,q,a))
e1∥e2=> or(valid(e1,q,a), valid(e2,q,a))
! e1=> not(valid(e1,q,a))

v@state=> if q[v]=state then true else false

v.event=>if a=v.event then true else false

endcase

A computation procedure (algorithm) of verification specification conversion performed in the verification specification conversion unit 12 of FIG. 1 is exemplified in the following.

A method for converting the intermediate verification specification 23 of the finite state machine into the program code (input verification specification) for performing the verification during execution of the program of verification object will be described below. For other verification methods, the input verification specification can be generated from the intermediate specification by the same method as far as the description of verification specification is in the form of the finite state machine. For example, it is naturally possible to convert the intermediate verification specification 23 into the input verification specification for the type state verification to perform the verification without executing the program. The removal effect of false counter-example can be obtained by generating the verification specifications corresponding to plural different verification methods and performing the program verification in accordance with each verification specification in the above manner.

The following procedure 5 is an example of generating the finite state machine defined in the verification specification in the format of an aspect oriented language AspectJ. The aspect outputted here is compiled along with the program of verification object, whereby it is possible to perform the verification by causing the state machine to transit during execution of the program. In the case where the counter-example occurs in the type state verification, it is effective in examining whether or not the corresponding path actually occurs by actually executing the program.

Procedure 5: Input verification specification generation

Input: intermediate specification M=(Q′, Σ, δ, q0, Q)

Output: Aspect module mounting the finite state machine

(1) Generate the aspect “aspect” of appropriate verification specification name Id with the qualifier “pertarget(obj( ))”.

aspect Id pertarget(target(Type)){ . . . }

(2) Declare the variable q holding the state Q for the member of aspect, and initialize it to the initial state q0.

aspect . . . {int q; . . . }

(3) Declare the array “delta[ ][ ]” for the member of aspect, and store the transition δ.

aspect . . . { . . . ; int delta[N][M]; . . . }

(4) Declare the pointcut statement corresponding to the object type “Type” for the member of aspect

aspect . . . { . . . ; pointcut obj( ): target(Type); . . . }

(4) Declare the pointcut statement corresponding to the event Σ for the member of aspect

aspect . . . { . . . ; pointcut evt( ): call( . . . ); . . . }

(5) Declare the advice corresponding to the pointcut statement of aspect, and describe the state transition.

aspect . . . { . . . ; before( ): evt( ){ . . . }; . . . }

advice corresponding to a in Σ

before( ): evt( ) {q=delta[q][a]; if(q==error)err( );}

The following example 9 of aspect accords with the notation of AspectJ language in Non-Patent Document 3 which is “An overview of AspectJ. “In Proceedings of the European Conference on Object-Oriented Programming, Budapest, Hungary, 18-22 Jun. 2001 (Gregor Kiczales, Erik Hilsdale, Jim Hugunin, Mik Kersten, Jeffrey Palm, and William G. Griswold). The interpretation of aspect of this example is that the processing system of the aspect oriented language generates “pertarget(obj( ))” the aspect with the name Id for each type “Type” and calls the advice “before( ):evt( ){ . . . }” if access to the object of type “Type” occurs.

### Example 9

### Input Verification Specification (Format of

```
aspect Id pertarget(obj( )) {
  int q = q0;
  int delta[ ][ ] = { ... };
  pointcut obj( ) : target(Type);
  pointcut evt1( ) : call(..);  // event a1
  ...
  before( ) : ev1( ) { q = delta[q][a1]; if (q == error) err( ); }
  ...
}
```

As described above, with this embodiment, the user separates the verification specification into the abstract specification and the concrete specification, describes the abstract specification and the concrete specification, and synthesizes both to generate the verification specification (or intermediate verification specification), whereby the effect of saving the description amount of verification specification can be obtained. Also, the reuse of abstract specification can be thereby repeatedly made.

Also, with this embodiment, the user separates the verification specification into the abstract specification and the concrete specification, describes the abstract specification and the concrete specification, and synthesizes both to generate the verification specification (or intermediate verification specification), whereby the effect of reducing the error in the complex verification specification can be obtained.

Also, with this embodiment, the user separates the verification specification into the abstract specification and the concrete specification, describes the abstract specification and the concrete specification, and synthesizes both to generate the verification specification (or intermediate verification specification), whereby the reuse of abstract specification can be thereby repeatedly made.

Also, with this embodiment, the user separates the verification specification into the abstract specification and the concrete specification, describes the abstract specification and the concrete specification, generates the intermediate verification specification from both, and converts the generated intermediate verification specification into the verification specification (input verification specification) corresponding to the individual verification method, whereby the removal effect of false counter-example can be obtained by performing the program verification in combination of plural different verification methods.

What is claimed is:

1. An apparatus which generates a verification specification for verifying a verification target program including functions operating one or more object, comprising:
a first input unit configured to input a first specification describing a first finite state machine which defines transitions among plural states due to occurrences of events;
a second input unit configured to input a second specification describing for a first object type, correspondence between functions operating an object having the first object type and the events in the first finite state machine; and
a verification specification generation unit configured to generate a verification specification for verifying the verification target program by synthesizing the first and second specifications, the verification specification describing a second finite state machine which defines the transitions among states of the object having the first object type due to calls of the functions operating the object having the first object type.

2. The apparatus according to claim 1, wherein
the first input unit inputs the first specification describing a plurality of the first finite state machines,
the second input unit inputs the second specification describing for object types different from each other, a plurality of the correspondences corresponding the first finite state machines, and
the verification specification generation unit generates a verification specification describing a third finite state machine which defines the transitions among combinations of states of the objects having the object types due to calls of the functions operating the objects having the object types.

3. The apparatus according to claim 2, wherein
the second specification further describes a logical expression which defines a constraint based on the state of the object and the occurrence of the event, and
the verification specification describes the third finite state machine which defines the transition to a predetermined state when a function call is occurred against the constraint.

4. The apparatus according to claim 3, wherein the predetermined state is an error state.

5. The apparatus according to claim 1, further comprising a program verification unit configured to verify the verification target program on a basis of the verification specification.

6. An method which generates a verification specification for verifying a verification target program including functions operating one or more object, comprising:
inputting a first specification describing a first finite state machine which defines the transitions among plural states due to occurrences of events;
inputting a second specification describing for a first object type, correspondence between functions operating an object having the first object type and the events in the first finite state machine; and
generating a verification specification for verifying the verification target program by synthesizing the first and second specifications, the verification specification describing a second finite state machine which defines the transitions among states of the object having the first object type due to calls of the functions operating the object having the first object type.

7. The method according to claim 6, wherein
the inputting a first specification includes inputting the first specification describing a plurality of the first finite state machines,
the inputting a second specification includes inputting the second specification describing for object types different from each other, a plurality of the correspondences corresponding the first finite state machines, and
the generating a verification specification includes generating a verification specification describing a third finite state machine which defines the transitions among combinations of states having the object types due to calls of the functions operating the objects having the object types.

8. The apparatus according to claim 7, wherein
the second specification further describes a logical expression which defines a constraint based on the state of the object and the occurrence of the event, and
the verification specification describes the third finite state machine which defines the transition to a predetermined state when a function call is occurred against the constraint.

9. The apparatus according to claim 8, wherein the predetermined state is an error state.

10. The apparatus according to claim 6, further comprising verifying the verification target program on a basis of the verification specification.

11. A computer readable medium storing a computer program for causing a computer which generates a verification specification for verifying a verification target program including functions operating one or more object, to execute instructions to perform the steps of:
inputting a first specification describing a first finite state machine which defines the transitions among plural states due to occurrences of events;
inputting a second specification describing for a first object type, correspondence between functions operating an object having the first object type and the events in the first finite state machine; and
generating a verification specification for verifying the verification target program by synthesizing the first and second specifications, the verification specification describing a second finite state machine which defines the transitions among states of the object having the first object type due to calls of the functions.

12. The medium according to claim 11, wherein
the inputting a first specification includes inputting the first specification describing a plurality of the first finite state machines,
the inputting a second specification includes inputting the second specification describing for object types different from each other, a plurality of the correspondences corresponding the first finite state machines and
the generating a verification specification includes generating a verification specification describing a third finite state machine which defines the transitions among combinations of states having the object types due to calls of the functions operating the objects having the object types.

13. The medium according to claim 12, wherein
the second specification further describes a logical expression which defines a constraint based on the state of the object and the occurrence of the event, and
the verification specification describes the third finite state machine which defines the transition to a predetermined state when a function call is occurred against the constraint.

14. The medium according to claim 13, wherein the predetermined state is an error state.

15. The medium according to claim 11, storing the computer program further for causing the computer to execute instructions to perform the step of verifying the verification target program on a basis of the verification specification.
